(19) United States
(12) Patent Application Publication
(10) Pub. No.: US 2015/0127392 A1
(43) Pub. Date: May 7, 2015

(54) SYSTEMS AND METHODS FOR TICKETED EVENT NOTIFICATIONS

(71) Applicants: Sudhir Kishan Shivakumar, Fremont, CA (US); Szuchi Wang, San Francisco, CA (US); Qing Guo, San Francisco, CA (US); Jayanth Vasudevan, Fremont, CA (US)

(72) Inventors: Sudhir Kishan Shivakumar, Fremont, CA (US); Szuchi Wang, San Francisco, CA (US); Qing Guo, San Francisco, CA (US); Jayanth Vasudevan, Fremont, CA (US)

(21) Appl. No.: 14/073,713

(22) Filed: Nov. 6, 2013

(51) Int. Cl. G06Q 10/00; G06Q 50/00

(52) U.S. Cl. CPC G06Q 10/00; G06Q 50/01
USPC 705/5

(57) ABSTRACT

Computing systems and methods for automatically providing event-related notifications to users are provided. Purchased-ticket events can be identified by scraping user emails. Ticket information such as dates and locations of events can also be gathered. User friends such as contacts in the user's social networks that have purchased tickets for the identified events may be identified. For future events, the user can be notified of friends that are attending the event, event-related vendor offers, ticket resale alerts, and event-time alerts. For past events, the user can be notified of shared comments or photos from friends or others. Consumers in a common geographical area with the user that have purchased tickets for the same events can also be identified. The user can be notified of identified neighbors attending the event or a community chat webpagc for the event can be provided.

### BACKGROUND

1. Technical Field

The present disclosure relates generally to electronic commerce, and more particularly, to the automatic generation of event-related notifications for purchased-ticket events.

2. Related Art

Event attendees such as concertgoers, sports fans, opera aficionados, etc., often purchase tickets for events. Before attending a purchased-ticket event, ticketholders often seek out additional information about the event such as whether they have friends that are attending the event or information about hotels or other services that are close to an event venue. After attending a purchased-ticket event, event attendees often seek out event-related memorabilia such as photos taken by friends at the event. However, seeking out these types of event-related information from various sources can be undesirably time consuming for someone who has purchased tickets for and/or attended an event. Moreover, a ticket purchaser may be unaware of additional available event-related information that could be helpful in attending, planning for, or remembering the event.

It would therefore be desirable to be able to provide systems and methods for automatic notification of event-related information for ticketed events.

### BRIEF DESCRIPTION OF THE DRAWINGS

FIG. 1 is a block diagram of an illustrative computing system that is adapted for implementing the selection and purchase of tickets for ticketed events according to an embodiment.

FIG. 2 is a block diagram of an illustrative computer system suitable for implementing on one or more devices of the computing system in FIG. 1 according to an embodiment.

FIG. 3 is a diagram of an illustrative user notification related to a ticketed event according to an embodiment.

FIG. 4 is a block diagram of an illustrative system for automatically generating notifications for ticketholders according to an embodiment.

FIG. 5 is a flowchart showing an illustrative process that may be performed by a ticket provider processor for automatically providing notifications for ticketholders according to an embodiment.

FIG. 6 is a diagram of an illustrative past-event notification related to a ticketed event according to an embodiment.

FIG. 7 is a diagram of an illustrative future-event notification related to a ticketed event according to an embodiment.

FIG. 8 is a diagram of a portion of an illustrative mobile device showing how a user notification may be displayed on a mobile device according to an embodiment.

FIG. 9 is a diagram of a portion of an illustrative mobile device showing how a user notification provided using the mobile device may include an event-time notification according to an embodiment.

FIG. 10 is a diagram of a portion of an illustrative webpage showing how a user notification such as a ticket-price notification may be provided on the webpage according to an embodiment.

FIG. 11 is a diagram of a portion of an illustrative webpage showing how a user notification such as an invite-friends notification may be provided on the webpage according to an embodiment.

FIG. 12 is a diagram of a portion of an illustrative webpage showing how a user notification such as a shared-photos notification may be provided on the webpage according to an embodiment.

FIG. 13 is a diagram of an illustrative user scrapbook webpage that may be used for providing user notifications according to an embodiment.

FIG. 14 is a flowchart showing another illustrative process that may be performed by a ticket provider for automatically providing notifications for ticketholders according to an embodiment.

FIG. 15 is a diagram of an illustrative community event chat webpage that may be used for providing user notifications according to an embodiment.

### DETAILED DESCRIPTION

Exemplary applications of apparatuses and methods according to the present invention are described in this section. These examples are being provided solely to add context and aid in the understanding of the invention. It will thus be apparent to one skilled in the art that the present invention may be practiced without some or all of these specific details. In other instances, well known process steps have not been described in detail in order to avoid unnecessarily obscuring the present invention. Other applications are possible, such that the following examples should not be taken as limiting.

In the following detailed description, references are made to the accompanying drawings, which form a part of the description and in which are shown, by way of illustration, specific embodiments of the present invention. Although these embodiments are described in sufficient detail to enable one skilled in the art to practice the invention, it is understood that these examples are not limiting, such that other embodiments may be used, and changes may be made without departing from the spirit and scope of the invention.

Devices, systems and methods are provided for performing activities related to the online purchase of tickets to ticketed events and to the automatic dissemination of event-related information associated with the ticketed events. In various particular embodiments, the devices, systems or methods can involve one or more devices in communication over a network. Such devices, systems, and methods can facilitate the selection and purchase of tickets to various ticketed events and/or the automatic delivery of event-related notifications associated with ticketed events to ticket purchasers.

While the various examples disclosed herein focus on particular aspects regarding automatically providing online ticket sales and automatic user notifications, it will be understood that the various inventive principles and embodiments disclosed herein can be applied to other types of ticketed-event applications and arrangements as well. For example, a ticket purchase or a user notification that is performed in person or on a closed or proprietary computing system may utilize one or more of the aspects and features found in the various systems and methods provided.

Reference throughout the specification to “various embodiments,” “some embodiments,” “one embodiment,” “an embodiment,” “various examples,” “one example,” “an example,” or “some examples” means that a particular feature, structure, or characteristic described in connection with the embodiment or example is included in at least one embodiment. Thus, appearances of these are not necessarily all referring to the same embodiment. Furthermore, the particular features, structures or characteristics may be combined in any suitable manner in one or more embodiments.

According to an embodiment, a computer program product can comprise a non-transitory machine readable medium. The non-transitory machine readable medium can have computer readable and executable code for instructing one or more processors to perform any of the methods disclosed herein.

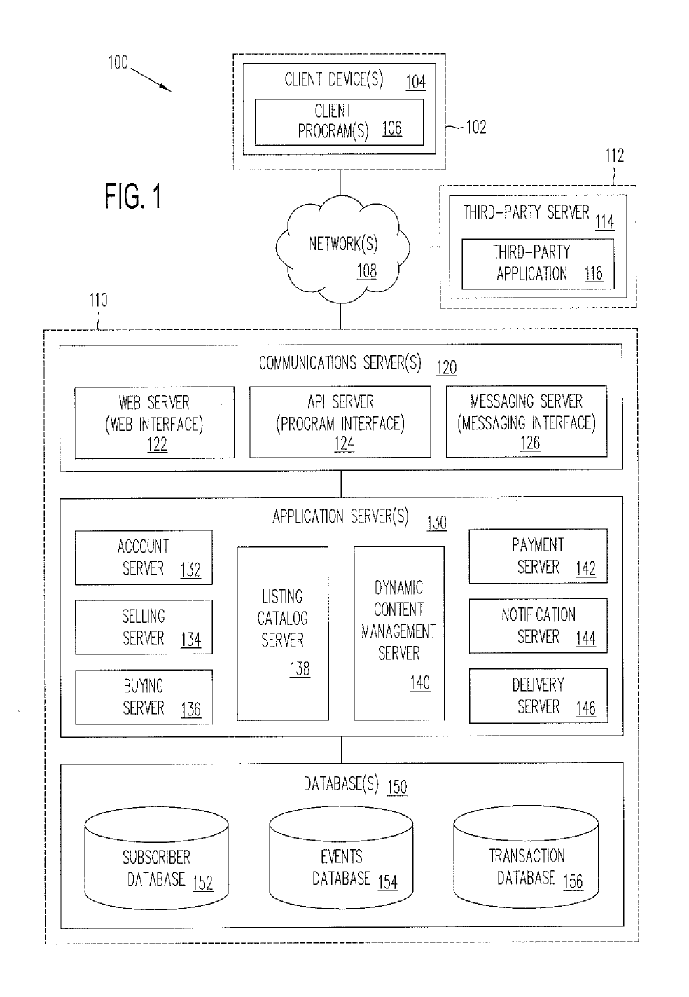

Beginning with FIG. 1, an exemplary embodiment of a computing system adapted for implementing the selection and purchase of tickets for ticketed events and/or, if desired, the automatic generation and delivery of notifications associated with ticketed events is illustrated in block diagram format. As shown, a computing system 100 may comprise or implement a plurality of servers and/or software components that operate to perform various methodologies in accordance with the described embodiments. Exemplary servers may include, for example, stand-alone and enterprise-class servers operating a server OS such as a MICROSOFT® OS, a UNIX® OS, a LINUX® OS, or other suitable server-based OS. It can be appreciated that the servers illustrated in FIG. 1 may be deployed in other ways and that the operations performed and/or the services provided by such servers may be combined or separated for a given implementation and may be performed by a greater number or fewer number of servers. One or more servers may be operated and/or maintained by the same or different entities,

Computing system 100 can include, among various devices, servers, databases and other elements, a client 102 that may comprise or employ one or more client devices 104, such as a laptop, a mobile computing device, a PC, and/or any other computing device having computing and/or communications capabilities in accordance with the described embodiments. In particular, it is specifically contemplated that client devices 104 can include a cellular telephone or other similar mobile device that a user can carry on or about his or her person and access readily.

Client devices 104 generally may provide one or more client programs 106, such as system programs and application programs to perform various computing and/or communications operations. Exemplary system programs may include, without limitation, an operating system (e.g., MICROSOFT® OS, UNIX® OS, LINUX® OS, Symbian OS™, Embedix OS, Binary Run-time Environment for Wireless (BREW) OS, JavaOS, a Wireless Application Protocol (WAP) OS, and others), device drivers, programming tools, utility programs, software libraries, application programming interfaces (APIs), and so forth. Exemplary application programs may include, without limitation, a web browser application, messaging applications (e.g., e-mail, IM, SMS, MMS, telephone, voicemail, VoIP, video messaging), contacts application, calendar application, electronic document application, database application, media application (e.g., music, video, television), location-based services (LBS) application (e.g., GPS, mapping, directions, point-of-interest, locator), and so forth. One or more of client programs 106 may display various graphical user interfaces (GUIs) to present information to and/or receive information from one or more of client devices 104.

As shown, client 102 can be communicatively coupled via one or more networks 108 to a network-based system 110. Network-based system 110 may be structured, arranged, and/or configured to allow client 102 to establish one or more communications sessions with network-based system 110 using various computing devices 104 and/or client programs 106. Accordingly, a communications session between client 102 and network-based system 110 (e.g., a communications session for selection and/or purchase of tickets for a ticketed event and/or a communications session for generating and delivering a user notification associated with one or more ticketed events) may involve the unidirectional and/or bidirectional exchange of information and may occur over one or more types of networks 108 depending on the mode of communication. While the embodiment of FIG. 1 illustrates a computing system. 100 deployed in a client-server operating environment, it is to be understood that other suitable operating environments and/or architectures may be used in accordance with the described embodiments.

Data and/or voice communications between client 102 and the network-based system 110 may be sent and received over one or more networks 108 such as the Internet, a WAN, a WWAN, a WLAN, a mobile telephone network, a landline telephone network, a VoIP network, as well as other suitable networks. For example, client 102 may communicate with network-based system 110 over the Internet or other suitable WAN by sending and or receiving information via interaction with a web site, e-mail, IM session, and/or video messaging session. Any of a wide variety of suitable communication types between client 102 and system 110 can take place, as will be readily appreciated. In particular, wireless communications of any suitable form may take place between client 102 and system 110, such as that which often occurs in the case of mobile phones or other personal mobile devices.

In various embodiments, computing system 100 can include, among other elements, a third party 112, which may comprise or employ a third-party server 114 hosting a third-party application 116, In various implementations, third-party server 114 and/or third-party application 116 may host a web site associated with or employed by a third party 112. For example, third-party server 114 and/or third-party application 116 may enable network-based system 110 to provide client 102 with additional services and/or information, such as additional ticket inventory. In one embodiment, third party server 112 may be a social networking server that hosts a user's social network account. In another embodiment, third party server 112 may be an email server that hosts a user's email account. In some embodiments, one or more of client programs 106 may be used to access network-based system 110 via third party 112. For example, client 102 may use a web client to access and/or receive content from network-based system 110 after initially communicating with a third-party web site 112.

Network-based system 110 may comprise one or more communications servers 120 to provide suitable interfaces that enable communication using various modes of communication and/or via one or more networks 108. Communications servers 120 can include a web server 122, an API server 124, and/or a messaging server 126 to provide interfaces to one or more application servers 130. Application servers 130 of network-based system 110 may be structured, arranged, and/or configured to provide various online marketplace and/or ticket fulfillment services and/or other ticket related services such as ticketed-event notification services to users that access network-based system 110. In various embodiments, client 102 may communicate with applications servers 130 of network-based system 110 via one or more of a web interface provided by web server 122, a programmatic interface provided by API server 124, and/or a messaging interface provided by messaging server 126. It can be appreciated that web server 122, API server 124, and messaging server 126 may be structured, arranged, and/or configured to communicate with various types of client devices 104 and/or client programs 106 and may interoperate with each other in some implementations.

Web server 122 may be arranged to communicate with web clients and/or applications such as a web browser, web browser toolbar, desktop widget, mobile widget, web-based application, web-based interpreter, virtual machine, and so forth. API server 124 may be arranged to communicate with various client programs 106 and/or a third-party application 116 comprising an implementation of API for network-based system 110. Messaging server 126 may be arranged to communicate with various messaging clients and/or applications such as e-mail, IM, SMS, MMS, telephone, VoIP, video messaging, and so forth, and messaging server 126 may provide a messaging interface to enable access by client 102 and/or third party 112 to the various services and functions provided by application servers 130.

When implemented as an online ticket marketplace, application servers 130 of network-based system 110 may provide various online marketplace and ticket fulfillment services including, for example, account services, buying services, selling services, listing catalog services, dynamic content management services, delivery services, payment services, scrapbooking services, and notification services. Application servers 130 may include an account server 132, a selling server 134, a buying server 136, a listing catalog server 138, a dynamic content management server 140, a payment server 142, a notification server 144, and/or a delivery server 146 structured and arranged to provide such online marketplace, ticket fulfillment and/or notification services. One or more of application servers 130 may be configured to gather event-related information such as purchased-ticket information, event dates, event times, event locations, event vendors, ticket resale prices, event-related photos, and event-related comments and generate a user notification using the gathered event-related information before, during, or after an event using the gathered event-related information.

Application servers 130, in turn, may be coupled to and capable of accessing one or more databases 150 including a subscriber database 152, an active events database 154, and/or a transaction database 156. Databases 150 generally may store and maintain various types of information for use by application servers 130 and may comprise or be implemented by various types of computer storage devices (e.g., servers, memory) and/or database structures (e.g., relational, object-oriented, hierarchical, dimensional, network) in accordance with the described embodiments.

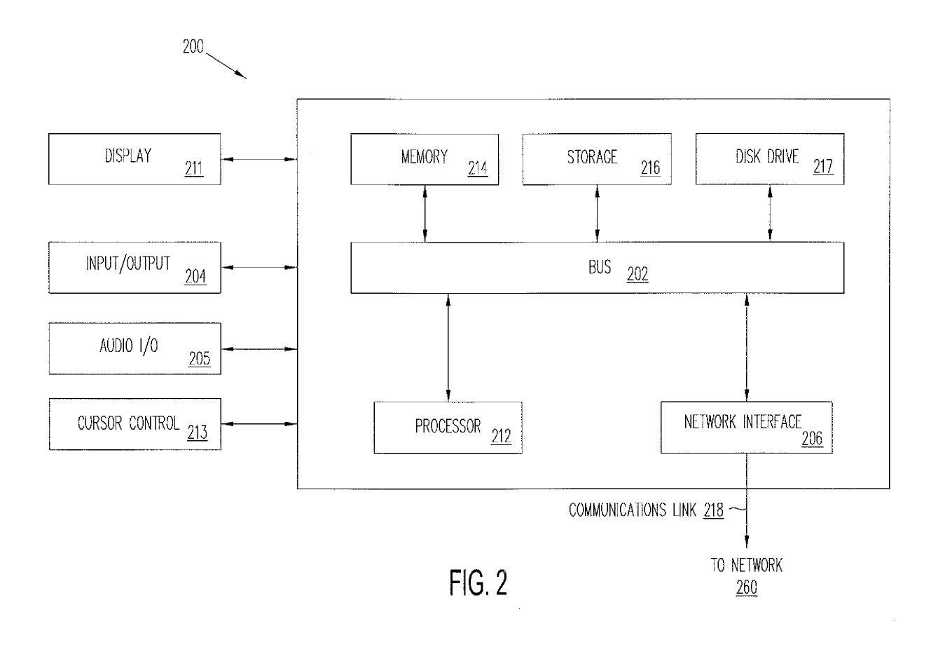

Continuing with FIG. 2, an exemplary computer system 200 suitable for implementing on one or more devices of the computing system in FIG. 1 is depicted in block diagram format. In various implementations, a device that includes computer system 200 may comprise a personal computing device (e.g., a smart or mobile phone, a computing tablet, a personal computer, laptop, PDA, Bluetooth device, key FOB, badge, etc.) that is capable of communicating with a network. The ticket provider and/or a payment provider may utilize a network computing device (e.g., a network server) capable of communicating with the network. It should be appreciated that each of the devices utilized by users, ticket providers, automatic notification providers, and payment providers may be implemented as computer system 200 in a manner as follows.

Computer system 200 can include a bus 202 or other communication mechanism for communicating information data, signals, and information between various components of computer system 200. Components include an input/output (I/O) component 204 that processes a user action, such as selecting keys from a keypad/keyboard, selecting one or more buttons or links, etc., and sends a corresponding signal to bus 202. I/O component 204 may also include an output component, such as a display 211 and a cursor control 213 (such as a keyboard, keypad, mouse, etc.). An optional audio input/output component 205 may also be included to allow a user to use voice for inputting information by converting audio signals. Audio I/O component 205 may allow the user to hear audio. A transceiver or network interface 206 transmits and receives signals between computer system 200 and other devices, such as another user device, a merchant server, a venue server, a third-party server or a payment provider server via a network. In various embodiments, such as for many cellular telephone and other mobile device embodiments, this transmission can be wireless, although other transmission mediums and methods may also be suitable. A processor 212, which can be a micro-controller, digital signal processor (DSP), or other processing component, processes these various signals, such as for display on computer system 200 or transmission to other devices over a network 260 via a communication link 218. Again, communication link 218 can simply be a wireless communication form in some embodiments. Processor 212 may also control transmission of information, such as cookies or IP addresses, to other devices.

Components of computer system 200 also include a system memory component 214 (e.g., RAM), a static storage component 216 (e.g., ROM), and/or a disk drive 217. Computer system 200 performs specific operations by processor 212 and other components by executing one or more sequences of instructions contained in system memory component 214. Logic may be encoded in a computer readable medium, which may refer to any medium that participates in providing instructions to processor 212 for execution. Such a medium may take many forms, including but not limited to, non-volatile media, volatile media, and transmission media. In various implementations, non-volatile media includes optical or magnetic disks, volatile media includes dynamic memory, such as system memory component 214, and transmission media includes coaxial cables, copper wire, and fiber optics, including wires that comprise bus 202. In one embodiment, the logic is encoded in non-transitory machine-readable medium. In one example, transmission media may take the form of acoustic or light waves, such as those generated during radio wave, optical, and infrared data communications.

Some common forms of computer readable media includes, for example, floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, or any other medium from which a computer is adapted to read.

In various embodiments of the present disclosure, execution of instruction sequences to practice the present disclosure may be performed by computer system 200. In various other embodiments of the present disclosure, a plurality of computer systems 200 coupled by communication link 218 to the network (e.g., such as a LAN, WLAN, PTSN, and/or various other wired or wireless networks, including telecommunications, mobile, and cellular phone networks) may perform instruction sequences to practice the present disclosure in coordination with one another. Modules described herein can be embodied in one or more computer readable media or be in communication with one or more processors to execute or process the steps described herein.

A computer system may transmit and receive messages, data, information and instructions, including one or more programs (i.e., application code) through a communication link and a communication interface. Received program code may be executed by a processor as received and/or stored in a disk drive component or some other non-volatile storage component for execution.

Where applicable, various embodiments provided by the present disclosure may be implemented using hardware, software, or combinations of hardware and software. Also, where applicable, the various hardware components and/or software components set forth herein may be combined into composite components comprising software, hardware, and/or both without departing from the spirit of the present disclosure. Where applicable, the various hardware components and/or software components set forth herein may be separated into sub-components comprising software, hardware, or both without departing from the scope of the present disclosure. In addition, where applicable, it is contemplated that software components may be implemented as hardware components and vice-versa.

Software, in accordance with the present disclosure, such as program code and/or data, may be stored on one or more computer readable mediums. It is also contemplated that software identified herein may be implemented using one or more general purpose or specific purpose computers and/or computer systems, networked and/or otherwise. Such software may be stored and/or used at one or more locations along or throughout the system, at client 102, network-based system 110, or both. Where applicable, the ordering of various steps described herein may be changed, combined into composite steps, and/or separated into sub-steps to provide features described herein.

The foregoing networks, systems, devices, and numerous variations thereof can be used to implement an automated user notification operation such as the generation of an event-related user notification for a user that has purchased tickets for one or more ticketed events. A user notification may include ticket information such as ticket-price information, event-time information, event-vendor information, event-related photos, event-related text, other event attendee information, or other information associated with one more ticketed events for which the user has purchased tickets.

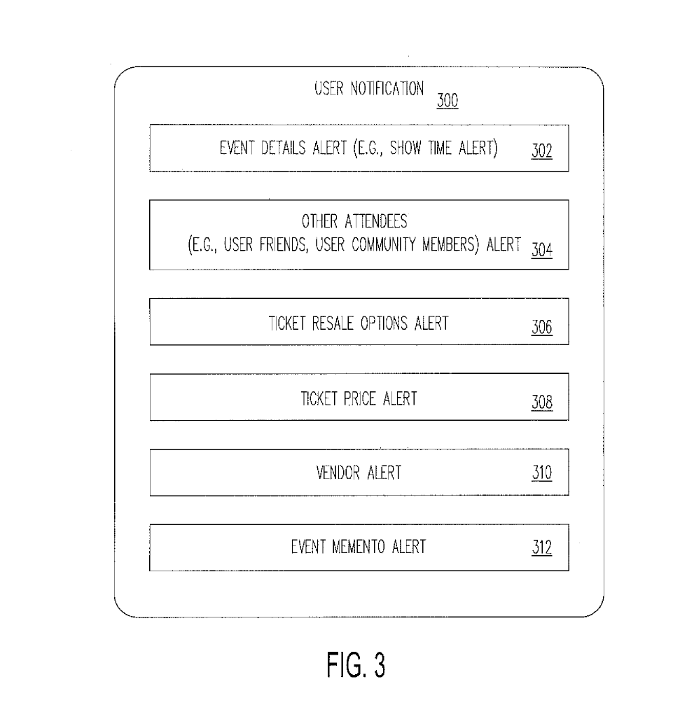

FIG. 3 is a diagram of an example of a user notification that can be generated and delivered using for example, a system such as system 100 of FIG. 1, by, for example, a ticket seller. As shown in FIG. 3, a user notification such as a user notification 300 may include one or more of various alerts such as an event-details alert 302 (e.g., a show-time alert, a venue-change alert, etc.), an other-attendees alert 304 (e.g., an alert that user friends or community members of a user of system 100 such as a ticket purchaser are attending an event, an alert that friends or community members of the user may be interested in an invitation to the event such as an invite-friends alert, or an alert that friends or community members of the user have invited the user to the event), a ticket resale options alert 306 (e.g., an alert notifying a user that they can resell tickets purchased from a ticket seller such as StubHub, Inc. or any other ticket seller on a ticket seller website such as a website of StubHub, Inc.), a ticket price alert 308 (e.g., an alert that the resale price of tickets purchased by the user has gone up, gone down, surpassed a threshold, etc.), a vendor alert 310 (e.g., an alert that a hotel, taxi company, restaurant, or other vendor is offering event-related products for sale), an event memento alert 312 (e.g., an alert that a friend or community member of the user has shared a photo or a comment associated with an event), or other suitable event-related alerts that may be helpful to a user for planning for, travelling to, attending, and/or memorializing a purchased-ticket event.

An event can be a concert, a sporting event, a theater event, a user-generated event, or any other type of event for which tickets are sold. Events can be past events that were attended by a user system 100, a current event that is currently being attended by a user, or a future event for which a user of system 100 has purchased tickets. User notification 300 may be generated and maintained by, for example, a ticket server from which the user has purchased one or more tickets to one or more ticketed events.

User notification 300 may be provided to a user by any suitable delivery means. As examples, user notification 300 may be delivered to a user in an e-mail, an IM, an SMS, an MMS, by an automated or in-person telephone call, by VoIP, by video messaging, on a social media webpage, using an API such as a ticket seller API installed on a user device, and/or on a memorabilia website such as an event scrapbook webpage that is automatically generated and maintained for a user by, for example, a ticket seller.

User notification 300 may be generated using, for example, notification server 144 of FIG. 1. User notification 300 may be provided to a user using, for example, web server 122, API server 124, and/or messaging server 126.

Event data such as ticket information, venue information, ticket sales information, ticket price information, attendee information, invitation information, and event-related mementos such as photos, photo captions, and event-related comments (as examples), may be automatically harvested from a user's account associated with user notification 300 (e.g., a user's account with a ticket seller that generates notification 300) and/or from other portions of the user's online presence such as one or more email accounts and/or social networking accounts associated with the user (e.g., a Facebook® account, a Twitter® account, an Instagram® account, a Pinterest® account, and/or a Google+® account).

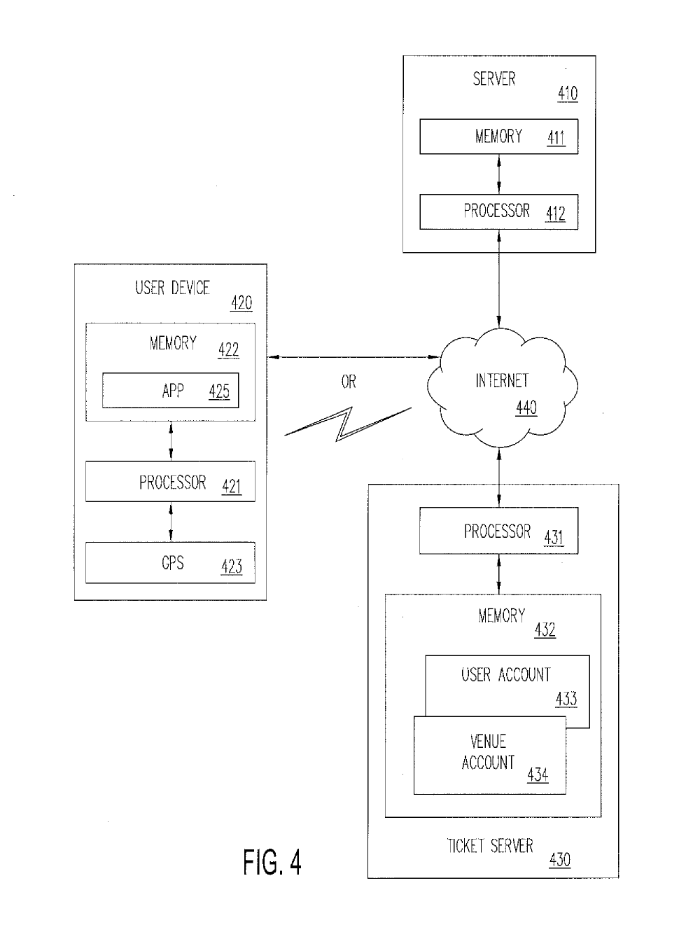

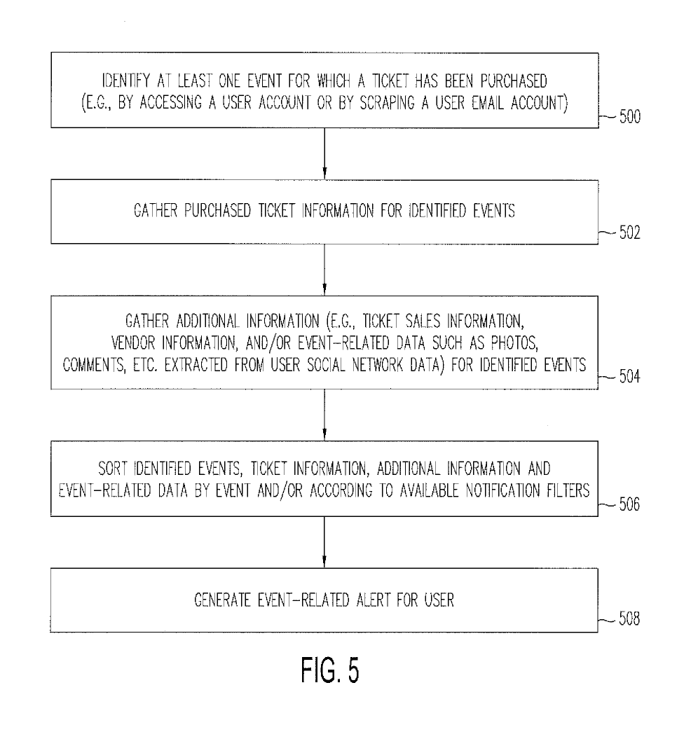

For example, as described in further detail below in connection with, for example, FIGS. 4 and 5, a server such as a server associated with a ticket seller (e.g., a ticket server) may obtain permission from a user to scrape the user's emails for ticketed-event information, extract the ticketed-event information from the user's emails, gather additional event information, obtain permission from the user to access social media accounts for event-related mementos such as event photos, event comments or other event-related media, extract the event-related mementos from the user's social media accounts, sort the extracted event-related mementos, the additional information, and the extracted ticketed-event information (e.g., based on time information and/or location information associated with the event-related mementos and the extracted ticketed-event information), and generate user notifications using the sorted event-related mementoes, additional information, and associated ticketed-event information.

FIG. 4 is a block diagram showing a user notification system, according to an embodiment. As shown in FIG. 4, a user device such as user device 420 may be in communication with one or more servers such as ticket server 430 and one or more additional servers 410. Servers 410 may include, for example, a social media server that hosts one or more social networking accounts for a user of user device 420 and an email server that hosts email services for the user. A user may use user device 420 to post photos, comments, or other data to a social networking site that is hosted by one of servers 410. The user may also use user device 420 to send, store, and receive emails or other electronic communications on an email account that is hosted by one of servers 410. The user may also use user device 420 to access ticket server 430 to select and purchase tickets for ticketed events from ticket server 430, to sell tickets for ticketed events, and/or to view user notifications generated by ticket server 430.

Ticket server 430 can obtain event-related information associated with particular users from servers 410 (e.g., by scraping emails in an email account that is hosted by a server 410, crawling webpages or otherwise accessing data in accounts hosted by a server 410). However, this is merely illustrative. If desired, user notifications may be generated by a notification server associated with ticket server 430 or a separate notification server that is not associated with server 430.

Ticket server 430 may, for example, be an implementation of system 110 of FIG. 1.

Server 410 can be a computer, a server, a computing tablet, or a mobile device, as examples. Server 410 can have processing circuitry such as processor 412 and storage such as memory 411.

A processor 412 on a server 410 can execute a software program stored in memory 411 for publishing user photos, comments, captions, or other data such that are posted by the user. A processor 412 on another server 410 can store and route emails or other communications for the user.

In one embodiment, servers 410 can be omitted if ticket server 430 has the information needed generate a user notification. For example, ticket server 430 may have a database of purchased tickets and information about the tickets, venues, vendors, user friends, and events to enable ticket server 430 to provide the necessary information generating user notifications.

A user can use a device such as a user device 420 to shop online for available tickets for one or more events, to post tickets on a ticket server for resale of the tickets, and/or receive a user notification related to the tickets that is automatically generated for the user. User device 420 can be a mobile device such as a cellular telephone, a tablet computer, a laptop computer, or another portable computing device. User device 420 can be a non-mobile device such as a home (land line) telephone, a desktop computer, an interactive set top box, or the like. User device 420 can be any device or combination of devices that facilitate online ticket purchasing, ticket selling, emailing, online posting of event-related information, and/or receiving of event-related notifications. User device 420 may, for example, be an implementation of client device 104 of FIG. 1.

User device 420 can have a processor 421, a memory 422, a global positioning system (GPS) 423 and/or other suitable device components. Processor 421 can execute an application such as an app 425 that facilitates ticket selection and purchase operations and/or user notification viewing operations. App 425 can be stored in memory 422. App 425 can provide a graphical user interface (GUI) for the user when the user is selecting and purchasing tickets online, selling tickets online, and/or viewing a user notification online. if desired, app 425 can be a dedicated ticket purchasing app. However, this is merely illustrative. In some configurations, app 425 can be part of another app, such as a Paypal, Inc. payment provider app.

User device 420 can communicate with servers 410 and/or ticket server 430 via a network. For example, user device 420 can communicate with server 410 and/or ticket server 430 via the Internet 440. User device 420 can communicate with the Internet via either a wired connection or a wireless connection.

Ticket server 430 may be operated by an online ticket seller such as StubHub, Inc. Ticket server 430 can facilitate online ticket sales. Ticket server 430 may include processing circuitry such as a processor 431 in communication with storage such as a memory 432. Processor 431 can include one or more processors. Processor 431 can access accounts such as a user account 433 and/or a venue account 434 that are stored in memory 332. User account 433 can include information regarding the user (e.g., identification information, preferences, account numbers, purchase history, social network contacts, email contacts, email account permissions, social media account permissions, event-related mementos, purchased-ticket event information, attended event information, etc.). Venue account 434 can include information regarding the venue at which past or future events occur (e.g., information regarding events, seating, and other venue features). Memory 432 can be separate from the ticker server and can be used to store any number of user accounts 433 and venue accounts 434. Memory 432 can be distributed, e.g., have portions thereof disposed at a plurality of different locations. Other accounts may also be accessible by processor 431, such as accounts of users selling tickets that include ticket details, such as price, quantity, location, and event information, and financial information that enables funds to be deposited into seller accounts when their tickets are sold. When a user wishes to shop for tickets online or sell tickets online, the user can open a ticket seller webpage or can access the ticket seller using an application such as app 425.

Ticket server 430 may include one or more servers located at one or more locations. Thus, the ticket server 430 can be geographically and operationally distributed if desired. Ticket server 430 can be part of another system, such as a payment provider system. Servers 410 can communicate with ticket server 430 over a wired or wireless connection such as via a network. For example, a server 410 can communicate with ticket server 430 via Internet 440. Servers 410 can communicate with a plurality of different ticket servers 430. Ticket server 430 can communicate with a plurality of different servers 410. A plurality of different ticket servers 430 can communicate among themselves and can be considered herein as being the same as a single ticket server 430. The user can operate user device 420 to interact with ticket server 430 so that the user can select and purchase tickets, receive event-related notifications, and/or view, update, share, or otherwise interact with an user scrapbook webpage associated with purchased tickets online.

Servers 410, user device 420, other mobile devices, and server 430 can communicate with one another via a network, such as the Internet 440 or via one or more other networks, such as local area networks (LANs), wide area networks (WANs), cellular telephone networks, and the like. Servers 410, user device 420, other mobile devices, and server 430, and other devices (e.g., a social network device) can communicate with one another, at least partially, via one or more near field communications (NFC) methods or other short range communications methods, such as infrared (IR), Bluetooth, WiFi, and WiMax.

In order to gather event information for generating user notifications for events for which a user has purchased tickets, computing equipment such as processor 431 of server 430 may perform some or all of the illustrative steps of FIG. 5.

At step 500, computing equipment such as one or more processors of ticket server 430, notification server 144 of system 110, other portions of system 110 or other suitable processors may identify at least one event for which a ticket has been purchased (e.g., by accessing a user account associated with the processor such as a user account on a ticket server or by scraping a user email account).

In one embodiment, the computing equipment may access a user's email account. A user's email account may include a list of emails (e.g., received emails or sent emails), each having email data such as a subject, a send date, body text, one or more senders, a recipient list (e.g., a carbon-copy (cc) list, a blind-carbon-copy (bcc) list, or other list of recipients of the email), or other data such as attached or embedded files. In some situations an email may be a confirmation email from a ticket seller notifying the email account holder that tickets for a ticketed event have been successfully purchased. Emails with purchased-ticket information such as confirmation emails from ticket sellers may be used to identify purchased-ticket events.

At step 502, purchased-ticket information for identified events may be gathered by the computing equipment. For example, some user emails, such as a confirmation email, can include ticket information such as the ticket price, the event date, the event artist or team (as examples), the seat section, the seat row, the seat number, the number of tickets, or other event information. This type of ticket information, along with any other information such as event information included in emails in a user's email account can be gathered by computing equipment (e.g., a processor of a notification server such as ticket server 330 or notification server 144) in an email scraping operation.

At step 504, the computing equipment may gather additional information for any identified events. The additional information may include ticket sales information such as ticket-price information (e.g., the average selling price of tickets that are similar in location to the purchased tickets, the most recent selling price of similar tickets, a predicted selling price of the purchased tickets), vendor information (e.g., contact information, price information, sale information, or other information for vendors associated with an identified event), and/or additional event-related data such as event mementos (e.g., photos taken at an event or comments posted on social media related to an event).

Vendors may include a hotel near an event venue, a transportation (e.g., taxi, limousine, and shuttle) service that offers transportation to an event venue, a restaurant near an event venue, an airline that offers flights to the event city or other vendors that offer goods or services that may be desired by attendees of a ticketed event.

The additional event-related data may be gathered by, for example, by computing equipment such as a processor of server 430 and/or server 144 by accessing one or more social network accounts such as a user's social network account or a social network account of one of the user's email contacts as determined by scraping a user's email account at step 500 or 502 and extracting the event-related data from the social network account(s). If desired, the computing equipment may crawl public webpages (e.g., social network webpages) of contacts identified in email contacts associated with a user's email account to obtain additional event-related data.

A social network account may include posted social networking data such as one or more photos, one or more photo captions, one or more comments (e.g., user comments or user friend comments), and one or more social network contacts. Photos, captions, and/or comments may be posted to a social medial account by the owner of account or by others. The computing equipment may gather the social networking data from the social network account.

The identified events, the ticket information and the additional information can be stored temporarily or permanently in a non-transitory memory such as memory 432 of ticket server 431, a memory such as memory 214 of FIG. 2, a memory of one of the servers of system 110 (e.g., memory associated with notification server 144) or other suitable data storage.

At step 506, the computing equipment may sort the identified events, the purchased-ticket information, and the additional information by event. Sorting the identified events, the ticket information, and the additional information may include associating the event-related data and the ticket information (and/or other additional gathered information) with appropriate ones of the identified events (e.g., by determining that a photo in the event-related data was taken during one of the obtained events from the user email using the time the photo was taken and an associated event time) and storing the associated information in a memory such as memory 432 of ticket server 430 (for example).

For example, a photo that is gathered from a user's social network webpage may have a time stamp corresponding to a time during a particular identified event, thereby indicating that the photo was taken at that event. As other examples, a photo may have been posted to the social network account during the identified event, may have a caption that refers to the identified event, may have a geographical tag associated with an event venue for the identified event, or may have image content that identifies the event (e.g., a venue sign, an identifiable venue feature or artist feature, etc.).

If desired, the identified events, the ticket information, and additional information may be further sorted and stored according to available notification filters selected by a user (e.g., an event-time filter, a ticket-price filter, an attendee filter, or other filters for determining which types of notifications a user desires to receive, and when and how the user prefers to receive the notifications). Sorting the identified events, the ticket information, and the additional information may include sorting the identified events into past events and future events.

The sorted identified events, ticket information, and the additional information can be stored temporarily or permanently in a non-transitory memory such as memory 432 of ticket server 431, a memory such as memory 214 of FIG. 2, a memory of one of the servers of system 110 (e.g., memory associated with notification server 144) or other suitable data storage.

At step 508, the ticket information and the additional information may be used to generate an event-related alert (e.g., a user notification) for the user.

In general, the steps described above in connection with FIG. 5 may be performed in any suitable order and/or combined in any suitable way for gathering event information and generating user notifications for ticketed events.

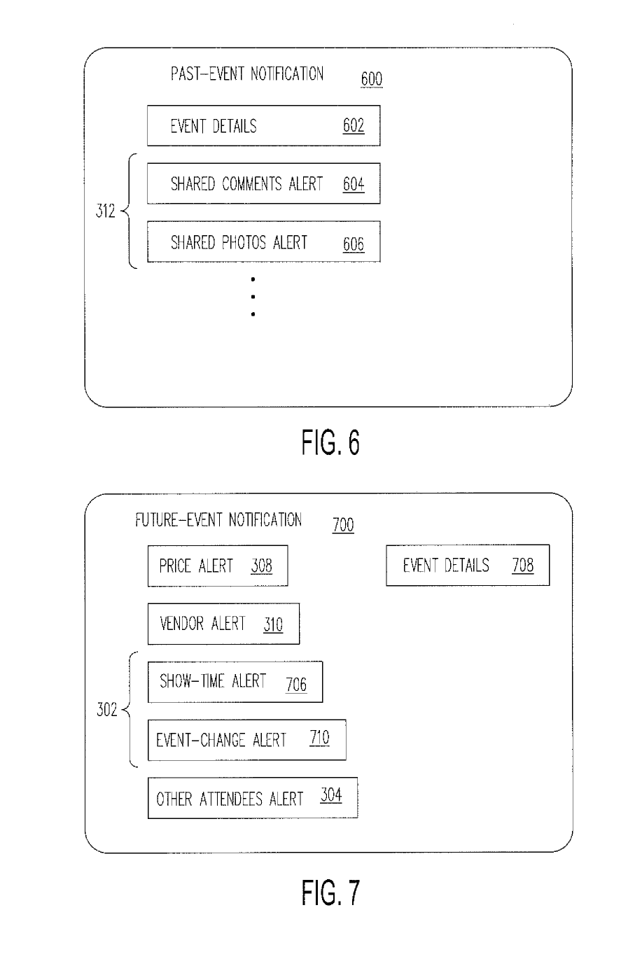

As described above in connection with step 506 of FIG. 5, identified events for which user notifications are to be generated may be sorted into past events (e.g., events that have already occurred) and future events (events that have not yet occurred). User notifications such as a user notification 300 for a past event may include different information than a user notification 300 for a future event. FIGS. 6 and 7 respectively show examples of a past-event notification and a future-event notification.

As shown in FIG. 6 a past-event notification such as past-event notification 600 may include event details 602 of the identified event (e.g., the artist/team/performer, event date, event time, event venue, event city, etc.), and event memento alerts 312 such as shared comments 604 (e.g., comments gathered from a user's social network account, a user's friends social network account, an event-related chat webpage, etc.) and shared photos 606 (e.g., photos gathered from a user's social network account, a user's friends social network account, an event-related chat webpage, etc.). For example, when a user's online contact posts a photo taken at a concert that was attended by the user, a past-event notification can be sent to the user as described herein notifying the user that a new event-related photo is available for viewing. If desired, the photo may be included in the notification or the notification can include a link to the photo or only a text or other notification that the photo was posted.

As shown in FIG. 7, a future-event notification such as future-event notification 700 may include a price alert 308, a vendor alert 310, event-details alerts 302 such as a show-time alert 706 and/or an event-change alert 710 (as examples), and/or an other-attendees alert 304. A future-event notification 700 may also include event details 708 (e.g., the artist/team/performer, event date, event time, event venue, event city, etc.). If desired, future-event notification 700 may include additional data such as event-related comments associated with a future event. Past-event notification 600 and future-event notification 700 of FIGS. 6 and 7 are merely illustrative. If desired, other notifications such as a current-event notification including alerts associated with an ongoing event may be generated and provided to a user and/or other information may be included in past, current, or future event notifications.

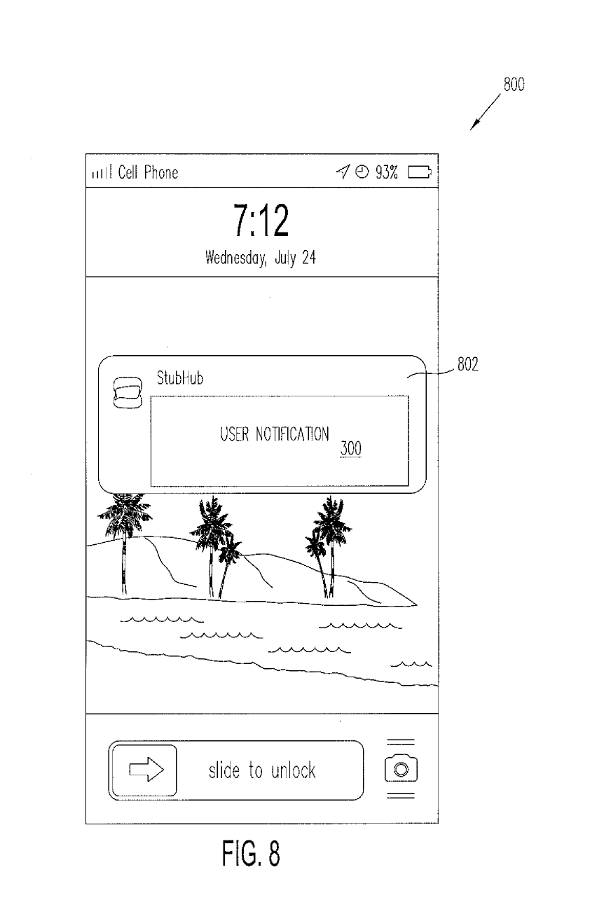

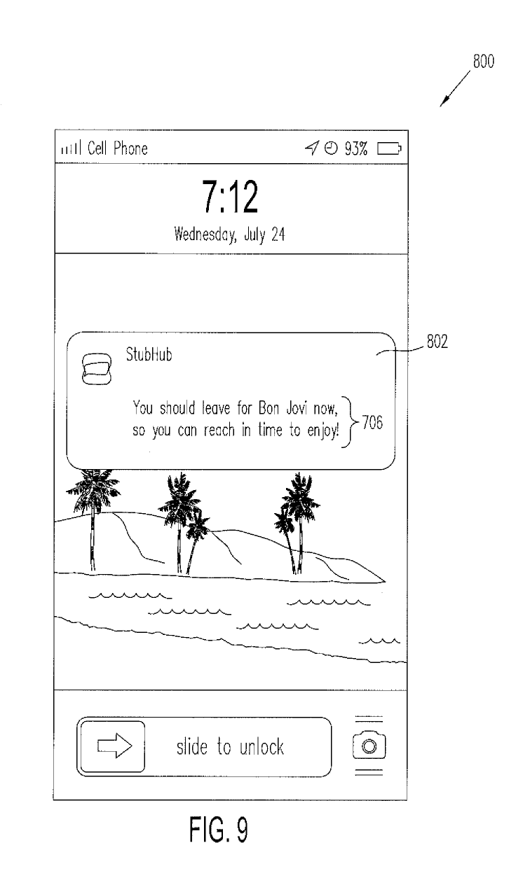

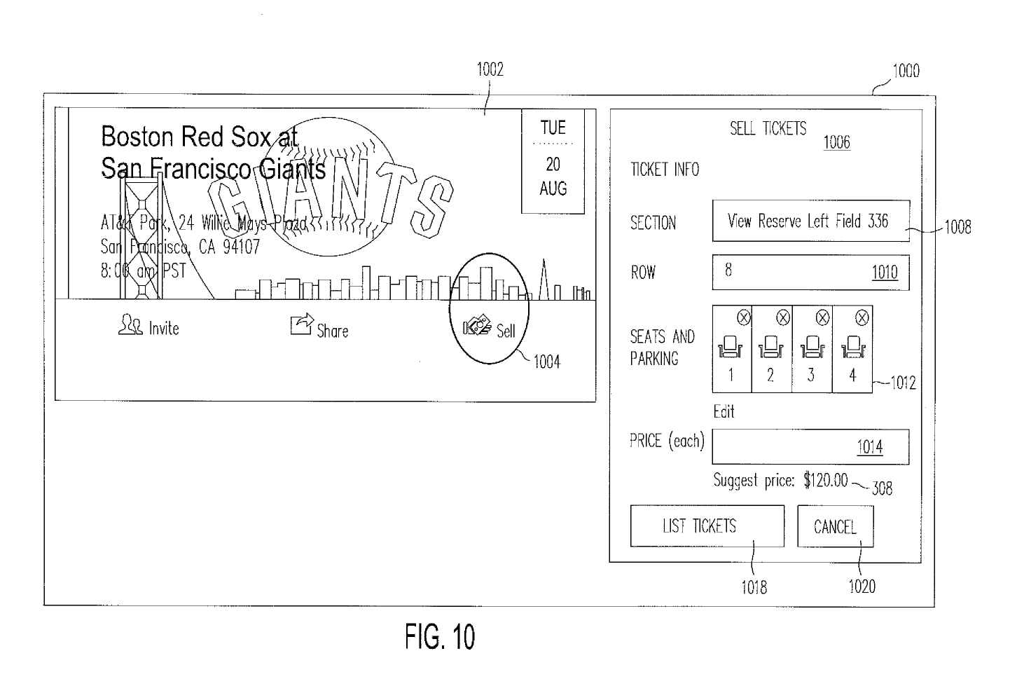

As discussed herein, user notifications can be provided to a user using various methods. FIGS. 8 and 9 show examples of user notifications that are provided to a user using an API installed on a user device. FIGS. 10, 11, and 12 show examples of user notifications that are provided to a user using a webpage that can be accessed by the user.

As shown in FIG. 8, user notification 300 may be provided to a user in an API window 802 on a smartphone 800 of the user. API window 802 may be configured by an API installed on smartphone 800 to pop up when the notification is received by the API from, for example, ticket server 430 of FIG. 4.

In the example of FIGS. 8 and 9, API window 802 is generated on a display of an iPhone® from Apple, Inc. However, this is merely illustrative. If desired, user notification 300 may be provided to the user in an API window in any portable or non-portable computing device such as user device 420 of FIG. 4.

FIG. 9 shows an example of a user notification in API window 802 that includes an event-time alert 706 (e.g., “You should leave for Bon Jovi now, so you can reach in time to enjoy!) that alerts a user that a purchased-ticket event (e.g., a Bon Jovi concert) is starting soon. The inclusion of event-time alert 706 is merely illustrative. If desired, any alerts or other notification as discussed herein may be provided to a user using an API window 802 on a user device.

As shown in FIG. 10, a user notification such as a ticket price alert 308 may be provided to a user on a webpage such as webpage 1000 associated with a future event (e.g., a baseball game to be played between the Boston Red Sox and the San Francisco Giants). Webpage 1000 may, if desired, by generated, maintained and hosted by a ticket server such as ticket server 430 (FIG. 4).

In the example of FIG. 10, ticket price alert 308 is provided in the form of a suggested ticket price of $120.00. A suggested ticket price of this type may be based on recent or projected ticket sales of similar tickets for the event (e.g., tickets in the same section, and/or row of the event venue). In this example, ticket price alert 308 is presented in a window such as sell window 1006 when a user selects a sell link 1004 (e.g., by clicking, mousing over, or finger tapping the link) associated with an event indicator such as future event indicator 1002 on the webpage. Sell window 1006 may be provided as a standalone window, a pop-up window, or may be otherwise provided to the user.

Sell window 1006 may include input fields for ticket information associated with the tickets that the user has purchased for the event associated with indicator 1002. The input fields may include a section field 1008, a row field 1010, a seats and parking field 1012, and a price field 1014. A user that desires to sell previously purchased tickets may enter ticket information into the input fields. In the example of FIG. 10, section field 1008 has been populated with section information “View Reserve Left Field 336”, row field 1010 has been populated with row information “8”, and seats and parking field 1012 has been populated with seat information “1”, “2”, “3”, and “4”. It will be appreciated that these examples are merely illustrative and that fields 1008, 1010, and 1012 can be populated with any suitable ticket sale information.

Fields 1008, 1010, and 1012 may be populated by the user by entering the appropriate information in the appropriate field based on the tickets the user wishes to sell. However, this is merely illustrative. If desired, fields 1008, 1010, and 1012 can be automatically populated by webpage 1000 (e.g., by the server that is hosting the webpage) using ticket information that was extracted from the user's account with the ticket seller and/or ticket information that was extracted by scraping the user's email or other accounts.

For example, if a user purchased the tickets associated with indicator 1002 from the ticket seller that is hosting the scrapbook webpage, the ticket seller can populate the ticket information fields of sell window 1006 using only information stored by the ticket seller. However, if the user purchased the tickets from another ticket seller, website 1000 may still be able to automatically populate the fields of sell window 1006 using the ticket information obtained in an email scrape. In this way, webpage 1000 may help a user resell tickets purchased from any ticket seller with minimal effort and time from the user in, for example, a one-click sell operation that allows the user to list the tickets for sale in a single click of for example, list tickets link 1.018.

If desired, price field 1014 may be populated by the user with a desired selling price for the tickets or price field 1.014 may be automatically populated (e.g., with a face-value price, or a suggested price based on the selling price of similar tickets at a current time). Ticket price alert 308 may be generated by a ticket seller that is hosting webpage 1000 based on other sales of tickets by the ticket seller or by other ticket sellers. For example, if tickets in the same section were recently sold for $120.00, a user may be provided with a suggested price of $120.00. Ticket price alert 308 may be updated at any suitable interval such as when new ticket sales information is gathered by the ticket seller or each time the user selects sell link 1004,

Sell window 1006 may provide the user with a “cancel” button 1020 that give the user an option for not selling the tickets associated with indicator 1002. If desired, an additional ticket price alert associated with an alert 308 on webpage 1000 can be delivered by email, by SMS, by API, or by other delivery methods to alert the user of, for example, a recent spike in the price of tickets similar to the user's tickets (e.g., a ticket price spike alert).

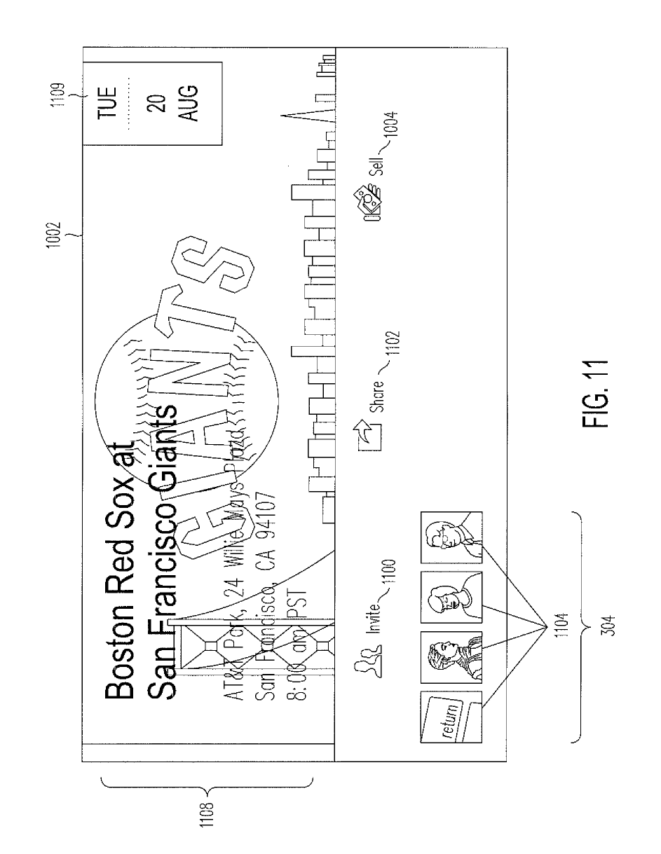

As shown in FIG. 11, an event indicator 1002 can include event information 1108 (e.g., an artist/team/performer/etc., an event venue, an event city, and/or an event time), an event date 1109, and additional links such as a share link 1102, and an invite link 1100 (sometimes referred to herein as an invite-friends link). Invite link 1100 may provide a user with options for inviting others to the associated event of the event indicator 1002. Share link 1102 may provide a user with options for posting information about the associated event to other online locations such as social network webpages or applications.

When a user selects invite link 1100 (e.g., by clicking, mousing over, or finger tapping the link), the user may be provided with one or more other-attendee alerts 304 such as potential attendee links 1104 to other users (e.g., email contacts of the user, social network contacts of the user, identified friends of the user, or others associated with the user or others who may be interested in the event). As shown in FIG. 11, links 1104 may be presented with icons associated with the other users. However, this is merely illustrative. If desired, links 1104 may be presented to the user as a list or may be otherwise presented to the user.

When a user selects one of links 1104, the user may be provided with options for sending an invitation to the other user associated with that link 1104. Invitation options may include an email option, a social network option, a text message option or other options for contacting the person that the user wishes to invite to the event.

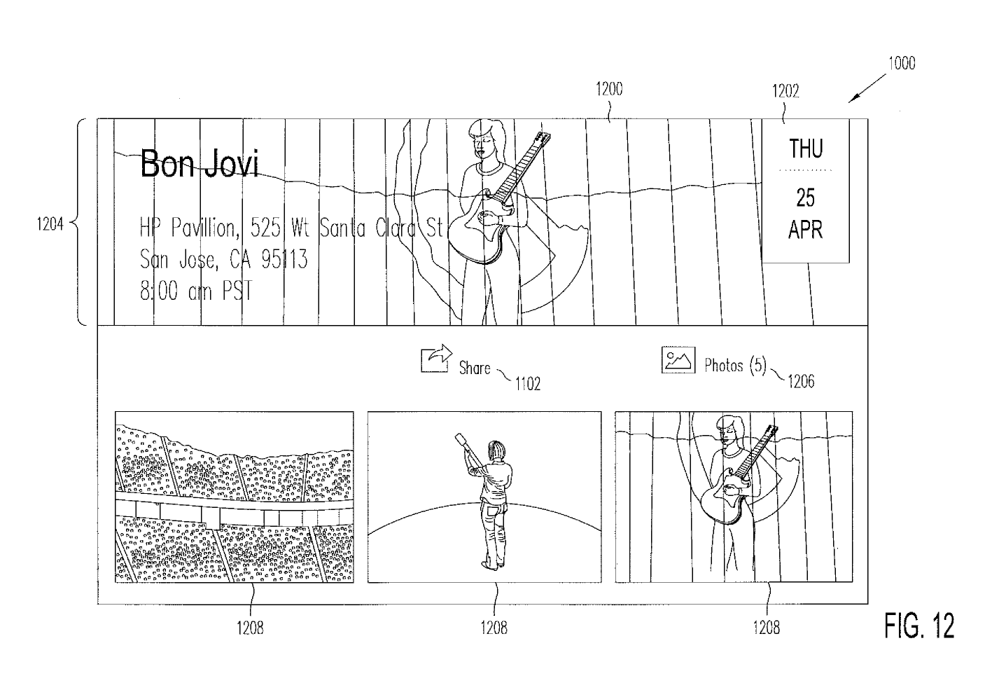

As shown in FIG. 12, webpage 1000 can include an additional event indicator such as a past-event indicator 1200. Past-event indicator 1200 can include past-event information 1204 (e.g., an artist/team/performer/etc., an event venue, an event city, and/or an event time), an event date 1202, and additional links such as a share link 1102, and a photos link 1206. Photos link 1206 may provide a user with options for displaying photos taken at the associated event of the event indicator 1200 (e.g., an event that was attended by the user). Photos link 1206 may include a shared-photos alert such as indication of the number of available photos (e.g., “(5)”) for viewing. When a viewer of webpage 1000 clicks, mouses over, or otherwise selects photos link 1206, the user may receive a shared photos alert that includes event photos 1208 associated with the past event indicator 1200 for the event at which the photos were taken. Photos 1208 may be gathered from a user's social network account (for example) as described above in connection with, for example, FIG. 5.

In the example of FIG. 12 three photos taken during a “Bon Jovi” event are shown. However, this is merely illustrative. If desired, any number of event-related photos may be displayed in connection with indicator 1200.

In some embodiments, website 1000 may be a user scrapbook webpage that is generated and maintained for the user by, for example, a ticket server from which the user has purchased one or more tickets.

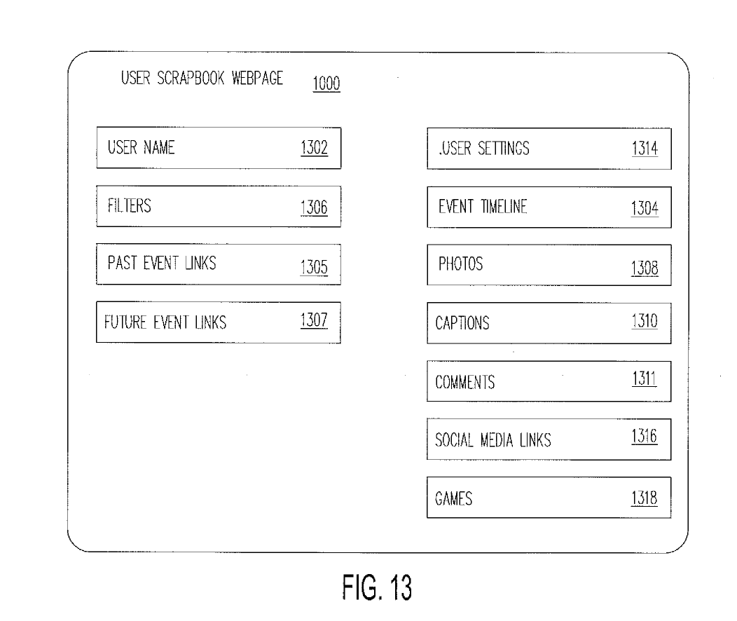

FIG. 13 shows an example of a website 1000 that has been implemented as a user scrapbook webpage. As shown in FIG. 13, a user scrapbook webpage may include user information such as a user name 1302 and/or user preferences 1314, event-related information such as an event timeline 1304, photos 1308, captions 1310, comments 1311, and/or event links such as past event links 1305 and/or future event links 1307, event-related gaming information or links such as games 1318, and website control features such as filters 1306.

Webpage 1000 may include an event timeline 1304. The event timeline may be a list of events for which the user has purchased tickets. The events may be displayed in a chronological order. The events may include past events and future events. Each event in timeline 1304 may include an associated event indicator such as event indicators 1002 and 1200 of FIGS. 10, 11, and 12 (as examples).

Some or all of user name 1302, filters 1306, links 1305 and 1307, photos 1308, captions 1310, comments 1311, social media links 1316, and/or games 1318 may, if desired, be presented as part of event indicators 1002 and/or 1200 on a webpage 1000.

In one embodiment, a ticket server may generate community-based user notifications associated with an event by determining other consumers in a common geographical area (e.g., a neighborhood, a city, a state, or a town) who purchased tickets for a common event with the user and notifies the user, creates a chat page for the event with the consumers, or takes other actions as desired.

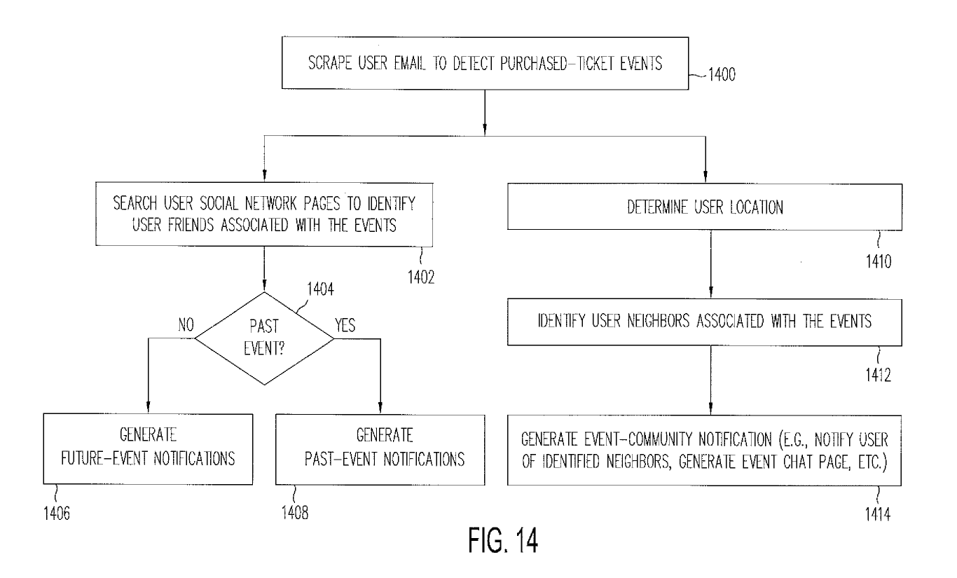

Illustrative steps that may be used in generating user notification such as past-event notifications, future-event notifications, and/or community-based notifications are shown in FIG. 14.

At step 1400, a user email account may be scraped to detect purchased-ticket events as described herein.

At step 1402, the user's social network accounts and/or pages (webpages) may be searched to identify user friends associated with the detected events as described herein.

At step 1404, it may be determined whether each detected event is a past event (e.g., whether each detected event has already occurred or has not already occurred).

In response to determining that an event is a past event, at step 1408, past-event notifications as described herein may be generated.

In response to determining that an event is not a past event (e.g., is a future event), at step 1406, future-event notifications (or, if desired, current-event notifications) may be generated.

After scraping the user email account at step 1400, at step 1410, the user's location (e.g., a user's geographical location) may also be determined.

At step 1412, one or more community members in the same geographical location (e.g., neighbors associated with the detected events such as neighbors that also purchased tickets for the detected event) may be identified. The “same” geographical location of the user may vary depending on various factors. For example, the user may define “same” as others in the same city as the user, within the same county as the user, or within the same five mile radius as the user's home. In other examples, the system may determine the distance from the user to qualify as neighbors. For example, in a rural, sparsely populated area, neighbors may be defined as within a 50 mile radius of the user, especially if there is only one airport or transportation hub nearby. On the other hand, in a densely populated urban area, neighbors may be defined as others within only 10 miles of the user's home location.

At step 1414, community-based notifications such as an event-community notification may be generated. For example, the user may be notified of identified neighbors that are attending the detected event, an event-community chat page may be generated, or other suitable community-based event alerts that may be helpful to the user in planning for, travelling to, attending, and/or memorializing the event may be generated.

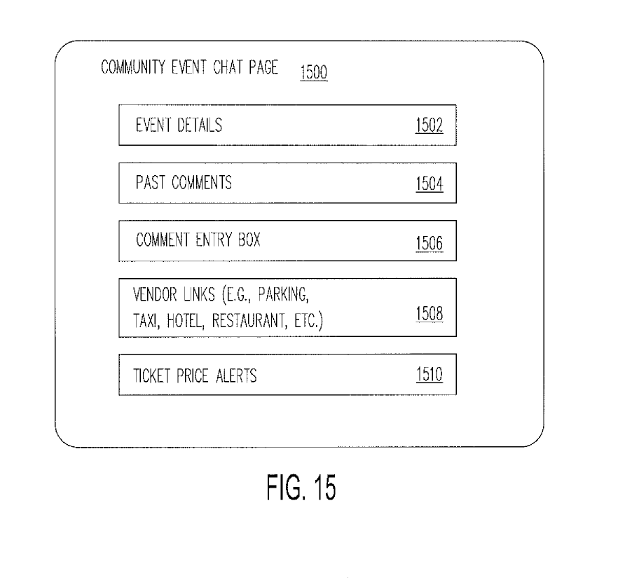

FIG. 15 shows an example of a community event chat page 1500 that may be generated at, for example, step 1414 of FIG. 14. As shown in FIG. 15, community event chat webpage 1500 may include event details 1502 of a particular event, past comments 1504 that have been posted by community members interested in the event (e.g., ticketholders), a comment entry box 1506 in which the user or others can enter new comments about the event or event-related topics, vendor links 1508 such as parking links, taxi links, hotel links, restaurant links or other vendor links as described herein, and/or alerts such as ticket price alerts 1510. Ticket price alerts 1510 may alert community members who might wish to purchase or sell tickets to the event using a ticket server of current, average, changing, or projected ticket sale prices for various types of tickets to the event.

In various embodiments, ticketed events such as the events described above can be social or recreational events, such as concerts, musicals, shows, fairs, amusement parks, sporting events and the like. Alternatively, such events can be business related events, such as business meetings, conferences, retreats, and the like.

Although the foregoing invention has been described in detail by way of illustration and example for purposes of clarity and understanding, it will be recognized that the above described invention may be embodied in numerous other specific variations and embodiments without departing from the spirit or essential characteristics of the invention. Various changes and modifications may be practiced, and it is understood that the invention is not to be limited by the foregoing details, but rather is to be defined by the scope of the claims.

What is claimed is:

1. A system for providing an event-related alert to a user, comprising:
a processor, configured to:
identify at least one event for which the user has purchased a ticket,
gather ticket information for the at least one event,
gather additional information associated with the at least one event, and
generate the event-related alert for the user based on the ticket information and the additional information; and
a non-transitory memory configured to store at least the ticket information and the additional information.

2. The system of claim 1, wherein the processor comprises a processor of a ticket server and wherein the processor is configured to identify the at least one event using a user account of the ticket server.

3. The system of claim 1, wherein the processor is configured to identify the at least one event by scraping an email account of the user.

4. The system of claim 3, wherein the processor is configured to gather the additional information by gathering event-related data from a social network account of the user.

5. The system of claim 4, wherein the event-related data includes a photo that was taken at the at least one event.

6. The system of claim 4, wherein the processor is further configured to:
identify user friends that are attending the at least one event using the event-related data, wherein the event-related alert comprises an other-attendees alert that notifies the user of the user friends that are attending the at least one event.

7. The system of claim 1, wherein the at least one event comprises a plurality of events and wherein the processor is further configured to sort the plurality of events into past events and future events.

8. The system of claim 1, wherein the additional information associated with the at least one event comprises ticket sales information.

9. The system of claim 8, wherein event-related alert comprises a ticket price spike alert for the user based on the ticket sales information.

10. A method, comprising:
scraping, electronically by a processor, a user email account of a user to detect a purchased-ticket event;
searching, electronically by the processor, a user social network account;
identifying, electronically by the processor, user neighbors associated with the purchased-ticket event; and
generating, electronically by the processor, at least one of a future-event notification, a past-event notification, or an event-community notification based on the scraping, the searching, and the identifying.

11. The method of claim 10, further comprising;
determining, electronically by the processor, whether the purchased-ticket event has already occurred.

12. The method of claim 11, further comprising:
in response to determining that the purchased-ticket event has already occurred, generating the past-event notification.

13. The method of claim 11, further comprising:
in response to determining that the purchased-ticket event has not already occurred, generating the future-event notification.

14. The method of claim 13, further comprising:
identifying, electronically by the processor, user friends associated with the purchased-ticket event, wherein the future-event notification includes information associated with the user friends.

15. The method of claim 10, further comprising:
determining a geographical location of the user, wherein the identifying comprises identifying other event attendees in the geographical location.

16. The method of claim 15, wherein the generating comprises generating the event-community notification and wherein the event community notification includes a community event chat page.

17. A non-transitory machine-readable medium having a plurality of machine-readable instructions which, when executed by one or more processors of a server, are adapted to cause the server to perform a method comprising:
identifying at least one event for which a user has purchased a ticket by scraping an email account associated with the user;
gathering ticket information for the at least one event based on the scraping;
gathering additional information associated with the at least one event; and
generating a user notification for the user based on the ticket information and the additional information.

18. The non-transitory machine-readable medium defined in claim 17, wherein the method further comprises:
sorting the at least one event into past events and future events.

19. The non-transitory machine-readable medium defined in claim 18, wherein the method further comprises:
providing at least one past-event notification to the user, wherein the at least one past-event notification includes a photo associated with the past events.

20. The non-transitory machine-readable medium defined in claim 18, wherein the method further comprises:
providing at least one future-event notification associated with the future events to the user, wherein the at least one future-event notification includes an alert selected from the group consisting of a price alert, a vendor alert, and an other-attendees alert.
